(19) United States
(12) Patent Application Publication
(10) Pub. No.: US 2006/0048140 A1
(43) Pub. Date: Mar. 2, 2006

(54) Method, system and article for generating installation merge packages

(75) Inventors: Emad Boctor, Toronto (CA); Andrew W. Hilden, Oshawa (CA)

Correspondence Address: Jerry W. Herndon;International Business Machines, Intellectual Property Law, Dept. T81/Bldg. 503, PO Box 12195, Research Triangle Park, NC, 27709, US

(73) Assignee: International Business Machines Corporation, Armonk, NY (US)

(21) Appl. No.: 10/930,599

(22) Filed: Aug. 31, 2004

(51) Int. Cl. G06F 9/445

(52) U.S. Cl. 717/175

(57) ABSTRACT

Disclosed is a method, data processing system and article of manufacture. The data processing system is operatively coupled to a data processing system usable memory tangibly embodying a software product installation package (SPIP) comprising software features (SFs) and software components (SCs) associated with the SFs. The data processing system implemented method is for generating a set of installation merge packages (IMPs). The data processing system implemented method includes associating a generated set of software feature merge packages (SFMPs) with a set of SFs selected from the SPIP, identifying a shared SC, the identified shared SC being shared by the selected set of SFs, inserting the identified shared SC into a generated common merge package (CMP)m associating the generated CMP with the generated set of SFMPs, and inserting the generated CMP and the generated set of SFMPs into the IMPs.

### FIELD OF THE INVENTION

The present invention relates to installation programs in general. More specifically, the present invention relates to a data processing system, a data processing system implemented method and an article of manufacture for generating installation merge packages, the installation merge packages to be subsequently amalgamated into a software product installation package which is subsequently used by a software product installer to install a software product.

### BACKGROUND

The installation of software programs to run on computing devices with modern operating systems can be complex. In addition to copying necessary files to the computing device, the installation of a program can often involve: determining which files are in fact necessary for the program to execute on a particular target computing device; creating necessary entries in registries or other operating system control structures; creating shortcuts; etc. Further, while a program may appear to be a monolithic item to a user, typically programs are in fact comprised of many different software components which must be installed correctly on the computing device for the program to execute.

To address these issues, many modern operating systems provide an installation program to effect the installation of the program onto the target computing device. To install a user program, the installation program processes an installation “package” created by the program provider and this installation package will include necessary files and/or components for the installation of the program and will also include information used by the installation program to perform the installation on the operating system, such as any entries which need to be made in registries or other operating system control structures, etc.

While the provision of installation programs has made the process of installing user programs much simper from the viewpoint of a user, the construction of installation packages by the program provider can be complex and is subject to error. Typically, the providers of programs expend a significant effort in constructing the installation package.

Another issue is that, in many cases, installation of a program in fact requires that multiple interdependent programs be installed by the installation program. For example, a user may wish to install an accounting application which requires that a database engine program also be installed for use by the accounting application. As will be apparent, a separate installation package can be supplied for each program, but this is typically undesired for several reasons, including the fact that it is often undesired to require a user to execute multiple installation procedures and that the installation of the programs may be interdependent, for example requiring that one program be installed before the other and with a particular setup or configuration.

However, the effort required to construct an installation package of two or more programs is correspondingly higher than that required for one. This effort can be further exacerbated by the fact that each of the interdependent programs may be authored by different groups in a company, or even by different companies.

One solution for dealing with the need to construct an installation package for multiple programs is to employ mergeable packages. A mergeable package is a specially constructed subset of an installation package which can be created to simplify creating an installation package for multiple programs. An installation package is created to install a first program and one or more mergeable packages are created to install a second program and these mergeable packages are then combined, or merged, with the installation package of the first program to create an installation package capable of installing both programs.

In the example above, the authors of the accounting application would create an installation package for their application and would be provided with a mergeable package, or packages, by the authors of the database engine program, the mergeable packages being combined with the installation package created for the accounting program to obtain an installation package to install both programs.

While mergeable packages provide a useful mechanism to include other programs into a single installation program, it still requires a significant effort to create a mergeable package and such creation is still subject to error.

### SUMMARY

It is an object of the present invention to provide a data processing system, data processing implemented method and article of manufacture for generating installation merge packages which obviates or mitigates at least one disadvantage associated with the prior art.

According to a first aspect of the present invention, there is provided, for a data processing system operatively coupled to a data processing system usable memory tangibly embodying a software product installation package (SPIP) comprising software features (SFs) and software components (SCs) associated with the SFs, a data processing system implemented method of generating a set of installation merge packages (IMPs), the data processing system implemented method comprising: associating a generated set of software feature merge packages (SFMPs) with a set of SFs selected from the SPIP; identifying a shared SC, the identified shared SC being shared by the selected set of SFs; inserting the identified shared SC into a generated common merge package (CMP); associating the generated CMP with the generated set of SFMPs; and inserting the generated CMP and the generated set of SFMPs into the IMPs.

According to another aspect of the present invention, there is provided a data processing system implemented method for directing a data processing system to construct, from an existing installation package used by an installation program to install a first computer program to be installed, at least one mergeable package to be merged with an installation package used by the installation program to install a second computer program, the first computer program having features implemented by components comprising portions of computer executable programs or data, the data processing system-implemented method comprising: analyzing the existing installation package for the first computer program to identify the features of the program and the components required to implement those features; and defining, for each feature of the first program, at least one mergeable package containing components required to install a respective feature such that the mergeable packages for the installation of the respective feature do not contain any components not required by that respective feature and that components do not occur redundantly within the defined mergeable packages.

According to yet another aspect of the present invention, there is provided a data processing system operatively coupled to a data processing system usable memory tangibly embodying a software product installation package (SPIP) comprising software features (SFs) and software components (SCs) associated with the SFs, the data processing system for generating a set of installation merge packages (IMPs), the data processing system comprising: an associating module for associating a generated set of software feature merge packages (SFMPs) with a set of SFs selected from the SPIP; an identifying module for identifying a shared SC, the identified shared SC being shared by the selected set of SFs; inserting module for inserting the identified shared SC into a generated common merge package (CMP); an association module for associating the generated CMP with the generated set of SFMPs; and an insertion module for inserting the generated CMP and the generated set of SFMPs into the IMPs.

According to yet another aspect of the present invention, there is provided a data processing system for directing a data processing system to construct, from an existing installation package used by an installation program to install a first computer program to be installed, at least one mergeable package to be merged with an installation package used by the installation program to install a second computer program, the first computer program having features implemented by components comprising portions of computer executable programs or data, the data processing system method comprising: an analyzing module for analyzing the existing installation package for the first computer program to identify the features of the program and the components required to implement those features; and a defining module for defining, for each feature of the first program, at least one mergeable package containing components required to install a respective feature such that the mergeable packages for the installation of the respective feature do not contain any components not required by that respective feature and that components do not occur redundantly within the defined mergeable packages.

According to yet another aspect of the present invention, there is provided an article of manufacture for directing a data processing system operatively coupled to a data processing system usable memory tangibly embodying a software product installation package (SPIP) comprising software features (SFs) and software components (SCs) associated with the SFs, the data processing system implemented method of generating a set of installation merge packages (IMPs), the article of manufacture comprising: a program usable medium embodying one or more instructions executable by the data processing system, the one or more instructions comprising: data processing system executable instructions for associating a generated set of software feature merge packages (SFMPs) with a set of SFs selected from the SPIP; data processing system executable instructions for identifying a shared SC, the identified shared SC being shared by the selected set of SFs; data processing system executable instructions for inserting the identified shared SC into a generated common merge package (CMP); data processing system executable instructions for associating the generated CMP with the generated set of SFMPs; and data processing system executable instructions for inserting the generated CMP and the generated set of SFMPs into the IMPs.

According to yet another aspect of the present invention, there is provided an article of manufacture for directing a data processing system to construct, from an existing installation package used by an installation program to install a first computer program to be installed, at least one mergeable package to be merged with an installation package used by the installation program to install a second computer program, the first computer program having features implemented by components comprising portions of computer executable programs or data, the article of manufacture comprising: a program usable medium embodying one or more instructions executable by the data processing system, the one or more instructions comprising: data processing system executable instructions for analyzing the existing installation package for the first computer program to identify the features of the program and the components required to implement those features; and data processing system executable instructions for defining, for each feature of the first program, at least one mergeable package containing components required to install a respective feature such that the mergeable packages for the installation of the respective feature do not contain any components not required by that respective feature and that components do not occur redundantly within the defined mergeable packages.

### BRIEF DESCRIPTION OF THE DRAWINGS

Preferred embodiments of the present invention will now be described, by way of example only, with reference to the attached Figures, wherein:

FIG. 1A shows an installation merge package generator and a set of installation merge packages generated by the installation merge package generator;

FIG. 1B shows an example of the installation merge packages of FIG. 1A;

FIG. 1C shows operation of the installation merge package of FIG. 1A;

FIG. 2 shows a block diagram representation of another installation merge package;

FIGS. 3A and 3B show a flowchart of a method for assembling the installation package of FIG. 2;

FIG. 4 shows a block diagram representation of a program, comprising features and components, to be installed onto a data processing system using the method of FIGS. 3A and 3B; and

FIG. 5 shows a block diagram of a data processing system for using the method of FIGS. 3A and 3B.

### DETAILED DESCRIPTION OF THE EMBODIMENTS

The following discussion refers to a specific example of an installation program, specifically the Microsoft Windows Installer V2.0, but the present invention is not limited for use in creating mergeable packages, referred to by Microsoft as merge modules, for this installation program and can instead be employed with any installation program that is capable of accepting mergeable packages, or components of packages, to install multiple programs from a single installation package. The Microsoft Windows Installer is described in a variety of readily available documents and its operation is well understood by those of skill in the art.

With the present invention, one or more mergeable packages can be created, in an automated manner, from a previously constructed installation package. Thus, the authors of a program need only create an installation package for their program, after which they can easily create necessary mergeable packages to allow their program to be installed with one or more other programs from a single installation package.

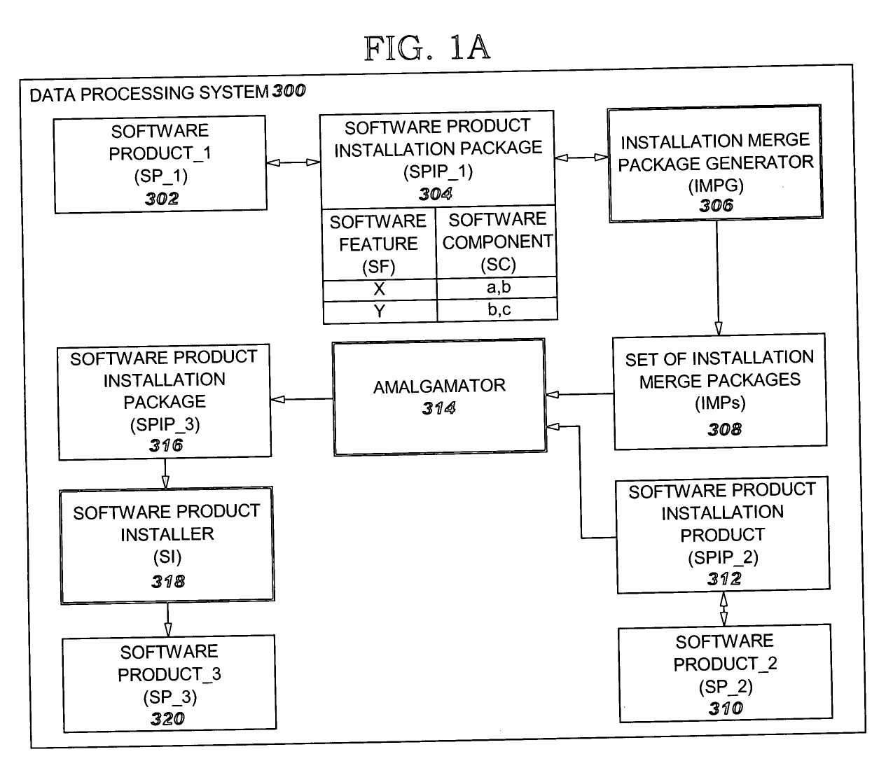

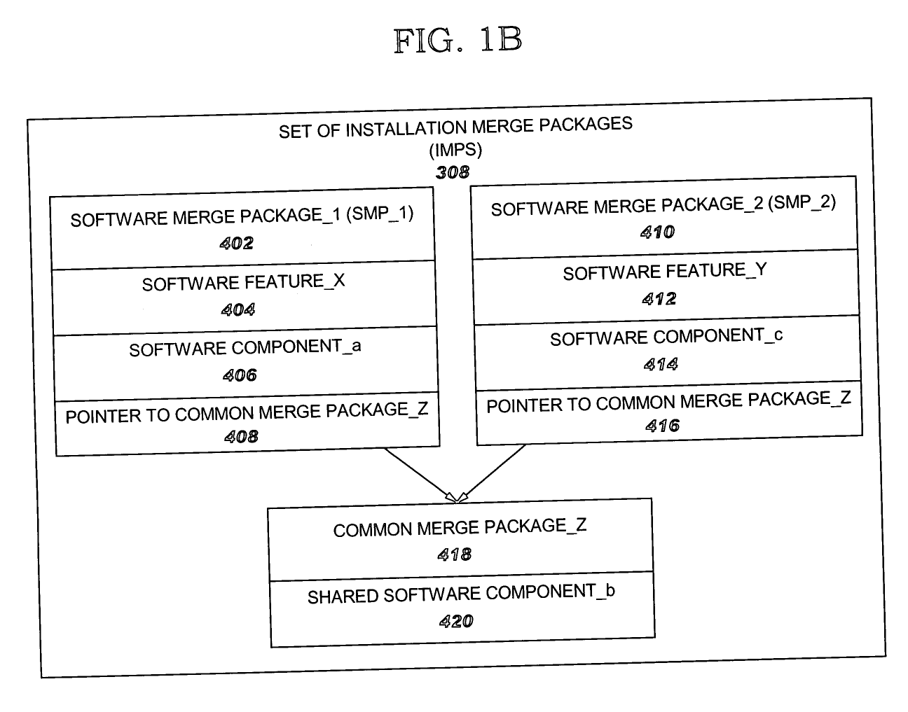

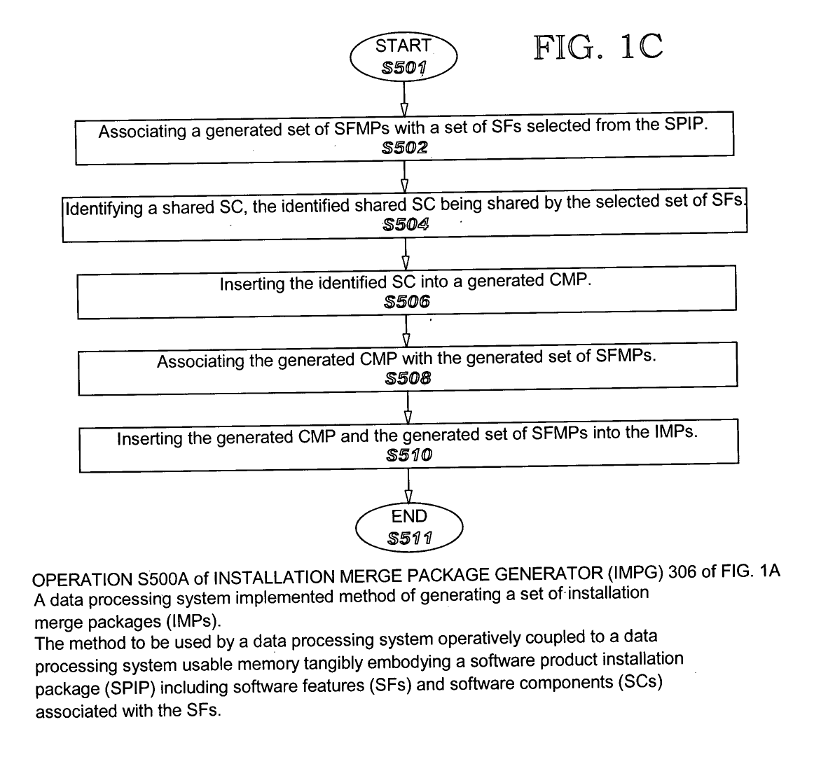

FIG. 1A shows a data processing system 300 operatively coupled to a data processing system usable memory (not shown). The memory tangibly embodies software artifacts indicated in FIG. 1A (and will be described below).

A software product_1 (SP_1) 302 represents a software program (for example, DB2 Universal Database manufactured by IBM Corp). Software product installation package (SPIP_1) 304 is associated with SP_1 302. SPIP_1 represents the software components (SCs) used to construct SP_1 302. For example, SPIP_1 may include a listing of software features (SFs) and their corresponding software components (SCs). Software feature X is associated with software components “a” and “b” (that is components “a” and “b” are used to construct software feature X). Software feature Y is associated with software components “b” and “c”.

An installation merge package generator (IMPG) 306 reads the SPIP_1 and then generates a set of installation merge packages (IMPs) 308.

An amalgamator 314 is a known software tool, and its operation will not be described here. An example of the amalgamator 314 is MERGMOD.dll Version 2.0 by Microsoft Corporation. The amalgamator 314 reads the IMPs 308 and a software product installation package (SPIP_2) 312. SPIP_2 is associated with a software product_2 (SP_2) 310 (for example, SP_2 may be IBM Rational Clearquest which uses a databases to store defect and change information). The output generated by the amalgamator 314 is a software product installation package (SPIP_3) 316.

A software product installer (SI) 318 such as Windows Installer by Microsoft Corporation, and its operation will not be discussed here. The SI 318 reads the SPIP_3 316 and generates a software product_3 (SP_3) 320.

FIG. 1B shows the IMPs 308 of FIG. 1A but in more detail. A software merge package_1 (SMP_1) 402 contains information such as a software feature_X 404 (that is a software feature identified in the SPIP_1), a software component_a 406 (that is, a software component identified in the SPIP_1), and a pointer to common merge package_Z 408. The common merge package includes a shared software component that is shared between a set of software merge packages. In the embodiment shown, common merge package_Z includes a software component (that is, software component b) which is shared by two software merge packages (that is, SMP_1 and SMP_2).

A software merge package_2 (SMP_1) 410 contains information describing a software feature_Y 412, a software component_c 414, and a pointer to common merge package_Z 416.

The common merge package_Z 418 contains a shared software component_b 420. The pointers represent a convenient way to associate the common merge package_Z 418 with SMP_1 and SMP_2.

FIG. 1C shows operation S500 of the installation merge package generator (IMPG) 306 of FIG. 1A. The IMPG 306 is executed by the data processing system 300. Operation S500 is a data processing system implemented method S500 which may be used for generating a set of installation merge packages (IMPs). The method S500 may be implemented as data processing system executable instructions tangibly embodied in a data processing system usable medium (such as a CD disk or network propagated signal). The data processing system may be operatively coupled to a data processing system usable memory tangibly embodying a software product installation package (SPIP) including software features and software components associated with the software features. The data processing system implemented method S500 includes operations S502 to S510 inclusive.

Operation S501 includes initializing the IMPG 306.

Operation S502 includes associating a generated set of SFMPs with a set of SFs selected from the SPIP. The generated set of SFMPs are SMP_1 and SMP_2, and the set of SFs is shown as software feature_X and software feature_Y (both software features are found in SPIP_1). The software feature_X is associated with SMP_1 and the software feature is associated with SMP_2.

Operation S504 includes identifying a shared SC, the identified shared SC being shared by the selected set of SFs. The shared SC, in this example, the software component_b (as listed in SPIP_1). The selected set of SFs are the software feature_X and the software feature_Y.

Operation S506 includes inserting the identified SC into a generated CMP (Common Merge Package). The shared software component_b is shown inserted into the common merge packages_Z.

Operation S508 includes associating the generated CMP with the generated set of SFMPs. This association may be implemented by inserting pointers in SMP_1 and SMP_2 which point to the common merge package_Z.

Operation S510 includes inserting the generated CMP and the generated set of SFMPs into the IMPs.

Operation S511 includes ending operation of the IMPG 306.

It will be appreciated that the operations S501 to S511 may all be implemented as data processing executable instructions tangibly embodied on data processing system usable medium, and that the instructions, when installed in the memory of the data processing system may be treated as operational modules.

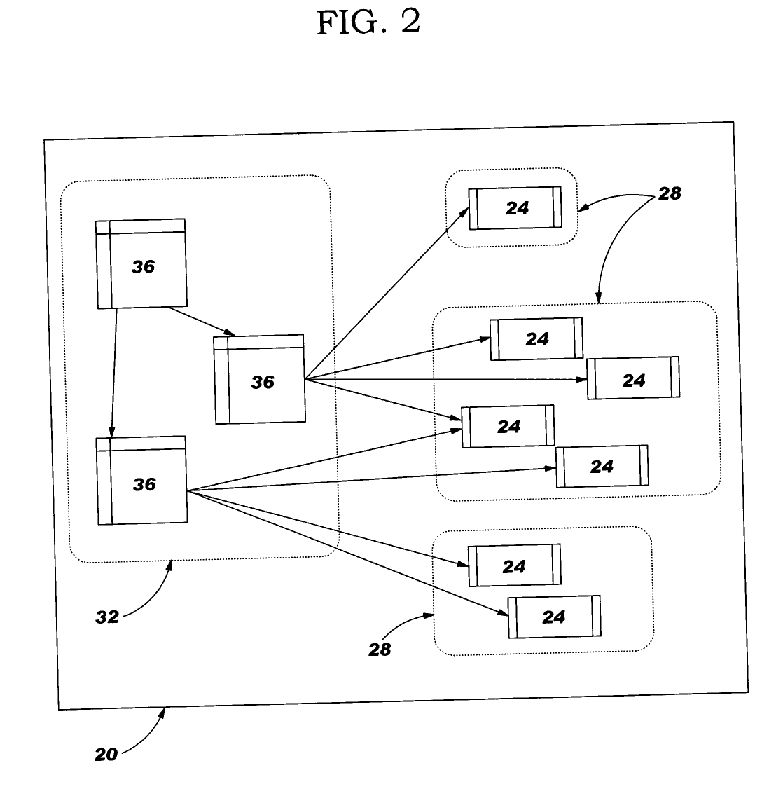

FIG. 2 shows another embodiment of an installation package 20. Package 20 includes a plurality of components 24, which can be stored separately, or in groups, in files 28. Components 24 are pieces of the program code and/or data to be installed and can include files, short cuts, libraries, operating control structure entries or other resources. The contents of components are related to one another and are always installed as a single coherent piece. Each component 24, whether grouped with others in a file 28 or in its own file 28, has a unique identifier assigned to it.

Package 20 further includes a database 32 comprising one or more data tables 36. Database 32 typically includes a predefined set of data tables 36 that are required by the installation program and can also include data tables 36 that are specific to the program or programs being installed. In the above-mentioned Windows Installer program, the set of required tables includes a Feature table, a FeatureComponent table and a Component table, amongst several others.

In the Windows Installer program, a feature is a part of the total functionality of a program which the user can decide to install independently. An example of a feature can be the spell checker in a word processing program, where the user can optionally decide whether or not to install the spell checker functionality. The Feature table lists all of the features in the program, the FeatureComponent table describes which components are required by each feature, and the Component table lists all of the components belonging to the program.

A mergeable package is a dataset which contains one or more program files, or data, for one or more components and a database which contains the information to create necessary entries in database 32 of an installation package that the mergeable package is to be merged into. The installation program will accept the mergeable package and will merge its contents into the installation package to be used to install the programs.

The present invention provides a method for the automated determination and construction of mergeable packages for installation programs to install a program. The program to be installed is arranged in features, comprising the portions of the program which can be specified separately for installation, and components comprising pieces of the program code to be installed. The method examines an existing installation package to identify the features in the program to be installed and the components required by those features. An arrangement of the components into mergeable packages is determined, the mergeable packages being designed to contain one or more components such that the mergeable package for the installation of a feature do not contain any components not required by that feature and that components do not occur redundantly within the mergeable packages. The dependencies between mergeable packages are determined and this dependency information is recorded in the merge package also.

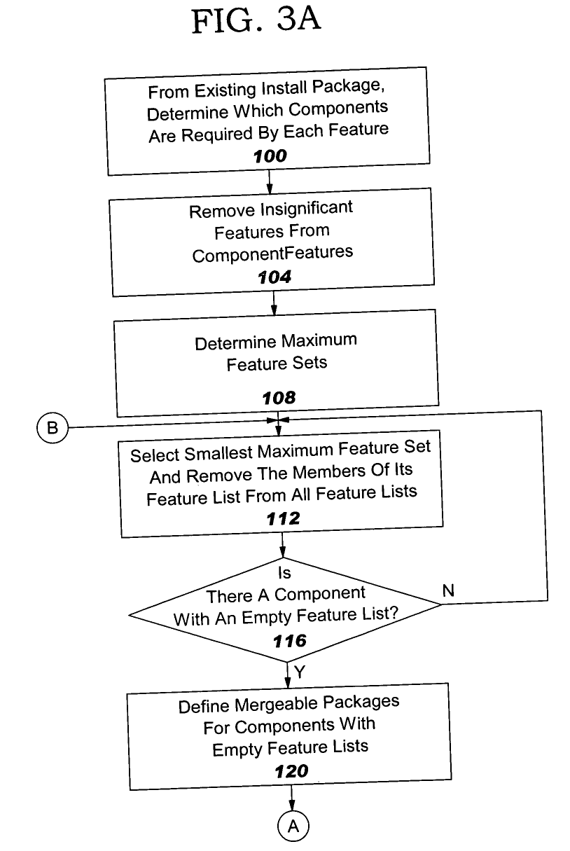

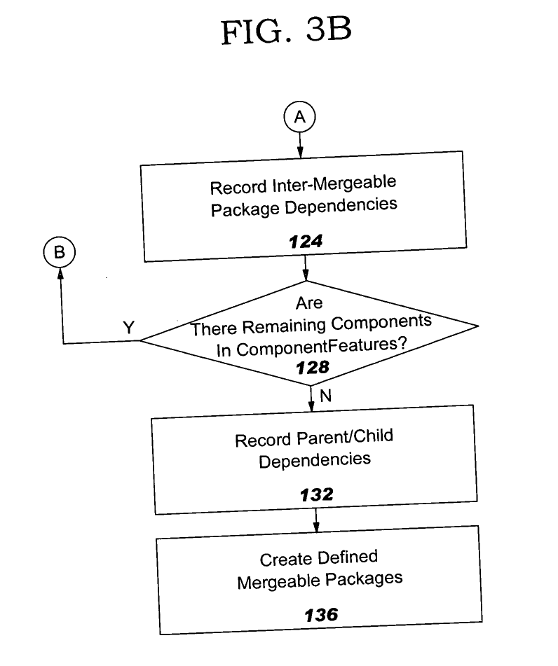

FIGS. 3A and 3B show a flowchart of an embodiment of the method in accordance with the present invention. The method commences at step 100, by examining an existing installation package, for the program for which the mergeable packages are to be created, to determine the components 24 which are required by each features. This can be accomplished in any suitable manner as will occur to those of skill in the art and, in the specific case of packages created for the Windows Installer program, is performed by examining the Component, Feature and FeatureComponent tables of database 32.

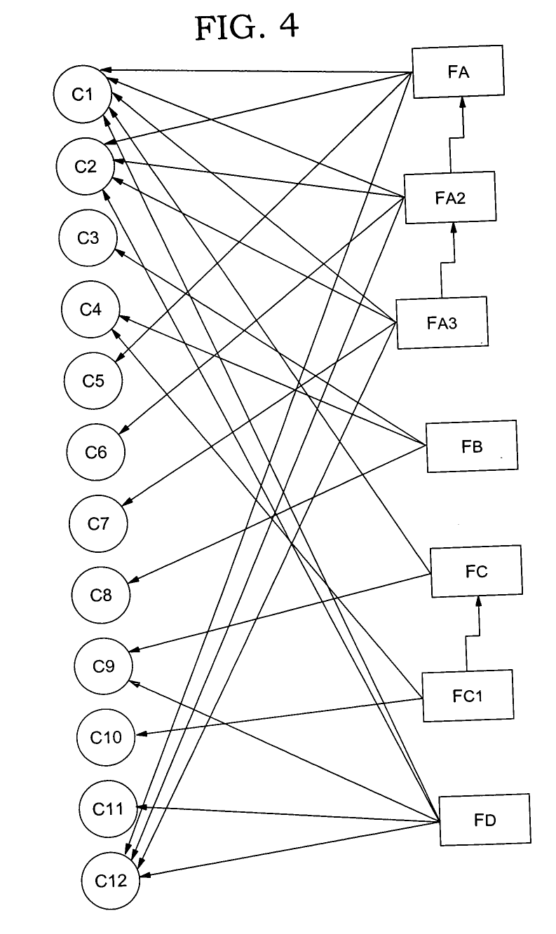

FIG. 4 shows the structure of the example program for which the installation package 20 has previously been constructed. As illustrated, this example program has seven features, F_{A}, F_{A2}, F_{A3}, F_{B}, F_{C}, F_{C1} and F_{D} and twelve components, C1, C2, C3, C4, C5, C6, C7, C8, C9, C10, C11 and C12. For this example, the results of step 100 will be as shown in the table below:

| Component | Feature List |
|---|---|
| C1 | F_{A}, F_{A2}, F_{A3}, F_{C}, F_{D} |
| C2 | F_{A}, F_{A2}, F_{A3}, F_{D} |
| C3 | F_{B} |
| C4 | F_{B}, F_{C1} |
| C5 | F_{A} |
| C6 | F_{A2} |
| C7 | F_{A3} |
| C8 | F_{B} |
| C9 | F_{C}, F_{D} |
| C10 | F_{C1} |
| C11 | F_{D} |
| C12 | F_{A}, F_{A2}, F_{A3}, F_{D} |

As shown, component C1 is required by features F_{A}, F_{A2}, F_{A3}, F_{C} and F_{D}, component C2 is used by features F_{A}, F_{A2}, F_{A3} and F_{D}, component C3 is used by feature F_{B}, etc.

As used herein, the term ComponentFeature is used to mean the information of a row of this table, namely the pairing of a component and the list of features which require it.

When constructing the mergeable packages, it is desired to provide efficiency and installation granularity. Specifically, it is desired that a feature to be installed only need install the components necessary for that feature. Thus, it is desired to form mergeable packages which contain the correct combinations of components to meet this criteria without having components contained redundantly within the mergeable packages.

The construction of an appropriate mergeable package, or mergeable packages, commences at step 104, where the method removes insignificant features from Feature Lists of the ComponentFeature information. A feature is deemed to be insignificant in the Feature List of a ComponentFeature if that feature is the child of another feature in the Feature List for that ComponentFeature.

A feature is designated a child of another feature if the installation of the child feature is subject to the installation of the parent feature. In the example above of the spell checker, a feature which allows users to modify dictionaries for the spell checker can be defined as a child of the spell checker feature, as such a “modify dictionary” feature cannot be installed if the spell checker feature is not installed.

The parent/child relationship between features can be determined in any suitable manner as will occur to those of skill in the art and, in specific example of the Windows Installer program, the Feature table includes a field in which to specify a parent for a feature.

In the example illustrated in FIG. 3, feature F_{A3} is a child of feature F_{A2} which, in turn, is a child of feature F_{A}. Thus, at step 104, the ComponentFeature for components C1, C2 and C12 are updated to remove features F_{A3} and F_{A2}, etc. as shown in the table below:

| Component | Feature List |
|---|---|
| C1 | F_{A}, F_{C}, F_{D} |
| C2 | F_{A}, F_{D} |
| C3 | F_{B} |
| C4 | F_{B}, F_{C1} |
| C5 | F_{A} |
| C6 | F_{A2} |
| C7 | F_{A3} |
| C8 | F_{B} |
| C9 | F_{C}, F_{D} |
| C10 | F_{C1} |
| C11 | F_{D} |
| C12 | F_{A}, F_{D} |

The method continues at step 108 wherein the Maximum Feature Sets are determined. Maximum Feature Sets are determined by identifying all the ComponentFeatures that contain the same feature in their Feature List and adding any other features that are in the same ComponentFeatures and which are not in any other ComponentFeature.

In the example of the program of FIG. 3, the list of Maximum Feature Sets would be:
F_{D}: C1; C2; C9; C11; and C12;
F_{A}: C1; C2; C5; and C12;
F_{B}: C3; C4; and C8;
F_{C1}: C4; and C10;
F_{C}: C1; and C9;
F_{A2}: C6; and
F_{A3}: C7

At step 112, the smallest Maximum Feature Set in the list is selected. In this example, both F_{A2} and F_{A3} have only a single member component, so feature F_{A3} is arbitrarily selected. The features from the selected smallest Maximum Feature Set, F_{A3} in this example, are then removed (indicated by the strikethrough in the table below) from each Feature List to obtain the reduced ComponentFeatures below:

| Component | Feature List |
|---|---|
| C1 | F_{A}, F_{C}, F_{D} |
| C2 | F_{A}, F_{D} |
| C3 | F_{B} |
| C4 | F_{B}, F_{C1} |
| C5 | F_{A} |
| C6 | F_{A2} |
| C7 | |
| C8 | F_{B} |
| C9 | F_{C}, F_{D} |
| C10 | F_{C1} |
| C11 | F_{D} |
| C12 | F_{A}, F_{D} |

Once features have been removed from the ComponentFeatures at step 112, a determination is made at step 116 as to whether the Feature List for one or more components is now empty. If no ComponentFeature has an empty Feature List, step 112 is performed again. If one of more ComponentFeatures have empty Feature Lists, mergeable packages are now defined for those ComponentFeatures at step 120 and the corresponding rows of ComponentFeatures are removed once the mergeable packages are created.

ComponentFeatures with empty Feature Lists which originally contained the same Feature Lists will be placed into the same mergeable package, and each remaining component with an empty Feature List will be placed in its own mergeable package. In this example, only component C7 has an empty Feature List, so a mergeable package MP_FA3 is defined for component C7. If a mergeable package is defined for a feature which also requires the components in another mergeable package, the dependency is recorded for the defined mergeable package at step 124. It should be noted features F_{A2} and F_{A} are prerequisites for feature F_{A3} as F_{A3} is a child of both of these features, but that no explicit steps need to be taken here to record this dependency as the child/parent relationships between F_{A3}, F_{A2} and F_{A} will deal with this dependency as discussed below.

At the end of step 124, the method has:

| Mergeable | Components in the | Prerequisites | Prerequisites |
|---|---|---|---|
| Package | Mergeable Package | (Components) | (Mergeable Packages) |
| MP_FA3 | C7 | None | None |

At step 128, a determination is made as to whether there are remaining features in the ComponentFeature list to be processed and, if there are, the process then steps repeats 112 to 128. In the example above, the next iteration of step 112 will result in feature F_{A2} being selected and removed from the ComponentFeatures which results in

| Component | Feature List |
|---|---|
| C1 | F_{A}, F_{C}, F_{D} |
| C2 | F_{A}, F_{D} |
| C3 | F_{B} |
| C4 | F_{B}, F_{C1} |
| C5 | F_{A} |
| C6 | |
| C8 | F_{B} |
| C9 | F_{C}, F_{D} |
| C10 | F_{C1} |
| C11 | F_{D} |
| C12 | F_{A}, F_{D} |

At step 116, it is determined that only component C6 has an empty Feature List, so at step 120 a mergeable package MP_FA2 is defined for component C6 and at the end of step 124, we have:

| Mergeable | Components in the | Prerequisites | Prerequisites |
|---|---|---|---|
| Package | Mergeable Package | (Components) | (Mergeable Package) |
| MP_FA3 | C7 | None | None |
| MP_FA2 | C6 | None | None |

Again, at step 128, a determination is made as to whether there are remaining features in the ComponentFeature list to be processed and, if there are, the process then steps repeats 112 to 128. In the example above, the next iteration of step 112 will result in one of features F_{C} or F_{C1}, which both have two components in their Features List, being arbitrarily selected and removed from the ComponentFeatures. Selecting F_{C} results in the following:

| Component | Feature List |
|---|---|
| C1 | F_{A}, F_{D} |
| C2 | F_{A}, F_{D} |
| C3 | F_{B} |
| C4 | F_{B}, F_{C1} |
| C5 | F_{A} |
| C8 | F_{B} |
| C9 | F_{D} |
| C10 | F_{C1} |
| C11 | F_{D} |
| C12 | F_{A}, F_{D} |

At step 116, it is determined that no component has an empty Feature List, so the process returns to step 112. The next iteration of step 112 will result in feature F_{C1} being removed from the ComponentFeatures, resulting in:

| Component | Feature List |
|---|---|
| C1 | F_{A}, F_{D} |
| C2 | F_{A}, F_{D} |
| C3 | F_{B} |
| C4 | F_{B} |
| C5 | F_{A} |
| C8 | F_{B} |
| C9 | F_{D} |
| C10 | |
| C11 | F_{D} |
| C12 | F_{A}, F_{D} |

At step 116, it is determined that component C10 now has an empty Feature List and so a mergeable package MP_FC1 module MP_FC1 is created. As feature F_{C1} also requires component C4, this dependency is recorded at step 124 and the result is:

| Mergeable | Components in the | Prerequisites | Prerequisites |
|---|---|---|---|
| Package | Mergeable Package | (Components) | (Mergeable Package) |
| MP_FA3 | C7 | None | None |
| MP_FA2 | C6 | None | None |
| MP_FC1 | C10 | C4 | None |

Step 128 determines that there are remaining components with non-empty Feature Lists, so the process returns to step 112 where F_{B} has the next smallest Maximum Feature Set and so is removed from the ComponentFeatures to yield:

| Component | Feature List |
|---|---|
| C1 | F_{A}, F_{D} |
| C2 | F_{A}, F_{D} |
| C3 | |
| C4 | |
| C5 | F_{A} |
| C8 | |
| C9 | F_{D} |
| C11 | F_{D} |
| C12 | F_{A}, F_{D} |

At step 116, it is determined that the Feature Lists for components C3, C4 and C8 are empty. At step 120, as C8 and C3 contained the same features, namely F_{B}, they can be assigned to the same mergeable package and so a mergeable package MP_FB is defined for them and a mergeable package MP_FB_C1 is defined for component C4.

At step 124 the dependencies for the new mergeable packages MP_FB and MP_FB_C1 are determined and recorded. As F_{B} is also a member of the Feature List for C4, this dependency is added at step 124. Further, as mergeable package MP_FB_C1 now contains component C4, the dependencies of MP_FC1 and MP_FB on C3 are mapped to the definition of MP_FB_C1 as shown.

| | Components in | | |
|---|---|---|---|
| Mergeable | the Mergeable | Prerequisites | Prerequisites |
| Package | Package | (Components) | (Mergeable Packages) |
| MP_FA3 | C7 | None | None |
| MP_FA2 | C6 | None | None |
| MP_FC1 | C10 | C4 | MP_FB_C1 |
| MP_FB | C3, C8 | C4 | MP_FB_C1 |
| MP_FB_C1 | C4 | | |

Step 128 determines that there are remaining components with non-empty Feature Lists, so the process returns to step 112 where F_{A} has the next smallest Maximum Feature Set and so is removed from the ComponentFeatures to yield:

| Component | Feature List |
|---|---|
| C1 | F_{D} |
| C2 | F_{D} |
| C5 | |
| C9 | F_{D} |
| C11 | F_{D} |
| C12 | F_{D} |

At step 116, it is determined that the Feature List for component C5 is empty and a mergeable package MP_FA is defined for component C5 at step 120. At step 124, the dependencies of feature F_{A} on components C1, C2 and C12 are determined to yield where the prerequisites in the definitions for MP_FC1 and MP_FB are updated to reflect the mergeable package containing their prerequisite component C4 as shown.

| | Components in | | |
|---|---|---|---|
| Mergeable | the Mergeable | Prerequisites | Prerequisites |
| Package | Package | (Components) | (Mergeable Packages) |
| MP_FA3 | C7 | None | None |
| MP_FA2 | C6 | None | None |
| MP_FC1 | C10 | C4 | MP_FB_C1 |
| MP_FB | C3, C8 | C4 | MP_FB_C1 |
| MP_FB_C1 | C4 | | |
| MP_FA | C5 | C1, C2, C12 | |

Step 128 determines that there are remaining components with non-empty Feature Lists, so the process returns to step 112 where F_{D} has the next smallest Maximum Feature Set and so is removed from the ComponentFeatures to yield:

| | |
|---|---|
| Component | Feature List |

C1
C2
C9
C11
C12

At step 116, it is determined that the Feature Lists for components C1, C2, C9, C11 and C12 are empty. As C2 and C12 contained the same features, namely F_{A} and F_{D}, a single mergeable package, MP_FA_FD, can be defined for them at step 120. Each of components C1, C9 and C11 have different members in their Feature Lists and so separate mergeable packages, MP_FA_FC_FD, MP_FC_FD and MP_FD respectively, are created for them at step 120.

At step 124, the dependencies of feature F_{D} on components C1, C2, C9 and C12 are noted. Similarly, the dependencies of feature F_{A} on components C1, C2 and C12 are noted and the definitions of MP_FA and MP_FD are updated to reflect the mergeable package containing their prerequisite components C1, C2 and C12 and C1, C2, C9 and C12 respectively, to yield

| | Components in | | Prerequisites |
|---|---|---|---|
| Mergeable | the Mergeable | Prerequisites | (Mergeable |
| Package | Package | (Components) | Package) |
| MP_FA3 | C7 | None | None |
| MP_FA2 | C6 | None | None |
| MP_FC1 | C10 | C4 | MP_FB_C1 |
| MP_FB | C3, C8 | C4 | MP_FB_C1 |
| MP_FB_C1 | C4 | | |
| MP_FA | C5 | C1, C2, C12 | MP_FA_FD, |
| | | | MP_FA_FC_FD |
| MP_FA_FD | C2, C12 | | |
| MP_FA_FC_ | C1 | C1, C2, C12 | |
| FD | | | |
| MP_FC_FD | C9 | | |
| MP_FD | C11 | C1, C2, C9, C12 | MP_FA_FD, |
| | | | MP_FA_FC_FD, |
| | | | MP_FC_FD |

At step 128, it is determined that there are no remaining components with non-empty Feature Lists, so the process proceeds to step 132.

At step 132 dependencies resulting from the parent/child relationships, mentioned above, are determined and added to the definitions. As mentioned above, feature F_{A3} is a child of feature F_{A2}. Mergeable package MP_FA3 will contain the components required by feature F_{A3} and mergeable package MP_FA2 will contain the components required by feature F_{A2}, its parent. Therefore, a prerequisite on mergeable package MP_FA2 is added to the definition of mergeable package MP_FA3.

Similarly, feature F_{A2} is the child of feature F_{A}. Mergeable package MP_FA2 will contain the components required by feature F_{A2} and mergeable packages MP_FA, MP_FA_FD and MP_FA_FC_FD will contain components required by feature F_{A}. Accordingly, the dependencies are recorded by adding a perquisite on mergeable package MP_FA2 to the definition of MP_FA. As the definition of MP_FA already has prerequisites on MP_FA_FD and MP_FA_FC_FD, no additional prerequisites need be added.

As is also mentioned above, feature F_{C1} is the child of feature F_{C} and mergeable package MP_FC1 will contain the components required by feature F_{C1} and mergeable packages MP_FA_FC_FD and MP_FC_FD will contain the components required by feature F_{C}. Therefore, prerequisites of MF_FC1 on MP_FA_FC_FD and MP_FC_FD are added to the appropriate mergeable package definitions.

The resulting mergeable packages information is

| | Components in | | Prerequisites |
|---|---|---|---|
| Mergeable | the Mergeable | Prerequisites | (Mergeable |
| Packages | Packages | (Components) | Packages) |
| MP_FA3 | C7 | None | MP_FA2 |
| MP_FA2 | C6 | None | MP_FA |
| MP_FC1 | C10 | C4 | MP_FB_C1, |
| | | | MP_FA_FC_FD, |
| | | | MP_FC_FD |
| MP_FB | C3, C8 | C4 | MP_FB_C1 |
| MP_FB_C1 | C4 | | |
| MP_FA | C5 | C1, C2, C12 | MP_FA_FD, |
| | | | MP_FA_FC_FD |
| MP_FA_FD | C2, C12 | | |
| MP_FA_FC_{—} | C1 | C1, C2, C12 | |
| FD | | | |
| MP_FC_FD | C9 | | |
| MP_FD | C11 | C1, C2, C9, C12 | MP_FA_FD, |
| | | | MP_FA_FC_FD, |
| | | | MP_FC_FD |

At step 136, the process completes by creating these mergeable packages. As mentioned above, each of the mergeable packages includes the component program code, or data, and the necessary installation information to install one or more features. Each mergeable package is provided with a unique identifier, and the resulting mergeable packages can be merged, via any suitable program tool, into an existing installation package for another program so that the installation program can use the resulting installation package to install both programs. This merger can be performed on the same system which performed the above-described method, or can be performed on another system which is provided with the mergeable packages.

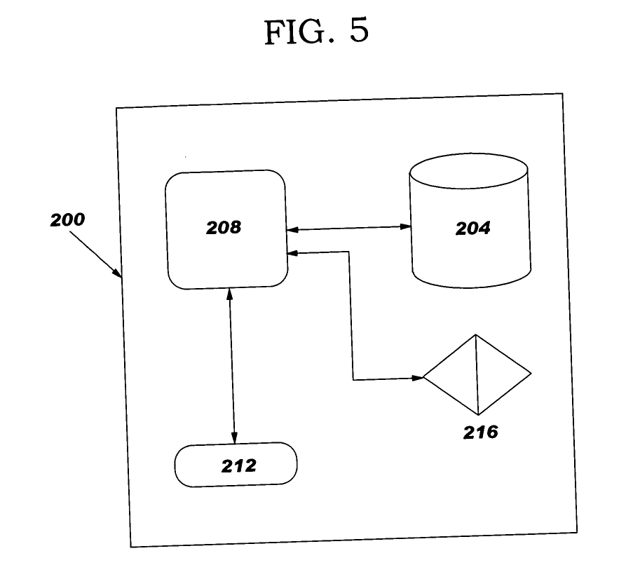

FIG. 5 shows a system 200 for creating mergeable packages in accordance with the present invention. System 200 can be implemented on a general purpose data processing system, such as an Intel Pentium 4 or PowerPC 2 processor or the like, with system memory, one or more mass storage devices, and preferably a network interface providing connectivity to a LAN or WAN network.

To perform the method of FIGS. 3A and 3B, system 200 implements a database engine 204, which can be any suitable database engine as will occur to those of skill in the art, including an SQL or flat file database engine. Database engine 204 is operative to create and maintain the definitions for mergeable packages and to add dependency information, if any, thereto. System 200 further implements an analyzer 208, which is operative to analyze an existing installation package to determine the features therein and the components required to implement them, and an arranger 212 which is operative to determine the arrangement of components necessary to implement features into mergeable packages, such that each mergeable package contains all of the components necessary to implement at least one feature without the resulting mergeable packages containing redundant components. System 200 further implements an identifier 216 which identifies dependencies, if any, between the components of mergeable packages and features of other mergeable packages. Database engine 204 creates appropriate definitions for mergeable packages from the information provided from analyzer 208, arranger 212 and identifier 216 and system 200 creates the necessary mergeable packages from the information provided by database engine 204.

The resulting mergeable packages can be provided, via a mass storage device such as a removable storage media or network interface, to a system having a merge tool and an installation package for a second program. This system can then merge the mergeable packages with the installation package for the second program to obtain a merged installation package which can be provided to an installation program to install both programs from the resulting installation package. As will be apparent to those of skill in the art, the present invention is not limited to creating mergeable packages for only one program and can instead be used to create mergeable packages for multiple programs if desired.

The detailed description of the embodiments of the present invention does not limit the implementation of the embodiments to any particular computer programming language. The embodiments may be implemented in any computer programming language provided that the OS (Operating System) provides the facilities that may support the requirements of the embodiments. A preferred embodiment is implemented in the C or C++ computer programming language (or other computer programming languages in conjunction with C/C++). Any limitations presented may be a result of a particular type of operating system, computer programming language, or data processing system and would not be a limitation of the embodiments.

The above-described embodiments of the invention are intended to be examples of the present invention and alterations and modifications may be effected thereto, by those of skill in the art, without departing from the scope of the invention which is defined solely by the claims appended hereto.

We claim:

1. For a data processing system operatively coupled to a data processing system usable memory tangibly embodying a software product installation package (SPIP) comprising software features (SFs) and software components (SCs) associated with the SFs, a data processing system implemented method of generating a set of installation merge packages (IMPs), the data processing system implemented method comprising:
associating a generated set of software feature merge packages (SFMPs) with a set of SFs selected from the SPIP;
identifying a shared SC, the identified shared SC being shared by the selected set of SFs;
inserting the identified shared SC into a generated common merge package (CMP);
associating the generated CMP with the generated set of SFMPs; and
inserting the generated CMP and the generated set of SFMPs into the IMPs.

2. The data processing system implemented method of claim 1 further comprising:
generating a SFMP, the generated SFMP having at least one SC associated with at least one SF of the SP.

3. A data processing system implemented method for directing a data processing system to construct, from an existing installation package used by an installation program to install a first computer program to be installed, at least one mergeable package to be merged with an installation package used by the installation program to install a second computer program, the first computer program having features implemented by components comprising portions of computer executable programs or data, the data processing system-implemented method comprising:
analyzing the existing installation package for the first computer program to identify the features of the program and the components required to implement those features; and
defining, for each feature of the first program, at least one mergeable package containing components required to install a respective feature such that the mergeable packages for the installation of the respective feature do not contain any components not required by that respective feature and that components do not occur redundantly within the defined mergeable packages.

4. The data processing system implemented method of claim 3 further comprising:
identifying dependencies between the mergeable packages and recording identified dependencies in the respective mergeable package definitions; and
creating the mergeable packages from the mergeable package definitions and the existing installation package for the first program, the mergeable packages containing components and the information required by the installation program to install them.

5. The data processing system implemented method of claim 4 wherein the installation program is the Microsoft Windows Installer program.

6. The data processing system implemented method of claim 5 wherein the analyzing of the existing installation package of the first program comprises examining the Feature, FeatureComponent and Component tables of the existing installation package for the first program.

7. The data processing system implemented method of claim 4 wherein each mergeable package created includes an identifier which is unique.

8. The data processing system implemented method of claim 4 further comprising merging the mergeable packages into the installation package for the second program to create an installation package for a combination of the first and second programs.

9. The data processing system implemented method of claim 4 further comprising repeatedly creating mergeable packages from an existing installation package for a third program.

10. A data processing system operatively coupled to a data processing system usable memory tangibly embodying a software product installation package (SPIP) comprising software features (SFs) and software components (SCs) associated with the SFs, the data processing system for generating a set of installation merge packages (IMPs), the data processing system comprising:
an associating module for associating a generated set of software feature merge packages (SFMPs) with a set of SFs selected from the SPIP;
an identifying module for identifying a shared SC, the identified shared SC being shared by the selected set of SFs;
inserting module for inserting the identified shared SC into a generated common merge package (CMP);
an association module for associating the generated CMP with the generated set of SFMPs; and
an insertion module for inserting the generated CMP and the generated set of SFMPs into the IMPs.

11. The data processing system of claim 10 further comprising:
a generating module for generating a SFMP, the generated SFMP having at least one SC associated with at least one SF of the SP.

12. A data processing system for directing a data processing system to construct, from an existing installation package used by an installation program to install a first computer program to be installed, at least one mergeable package to be merged with an installation package used by the installation program to install a second computer program, the first computer program having features implemented by components comprising portions of computer executable programs or data, the data processing system method comprising:
an analyzing module for analyzing the existing installation package for the first computer program to identify the features of the program and the components required to implement those features; and
a defining module for defining, for each feature of the first program, at least one mergeable package containing components required to install a respective feature such that the mergeable packages for the installation of the respective feature do not contain any components not required by that respective feature and that components do not occur redundantly within the defined mergeable packages.

13. The data processing system of claim 12 further comprising:
an identification module for identifying dependencies between the mergeable packages and recording identified dependencies in the respective mergeable package definitions; and
a creating module for creating the mergeable packages from the mergeable package definitions and the existing installation package for the first program, the mergeable packages containing components and the information required by the installation program to install them.

14. The data processing system of claim 13 wherein the installation program is the Microsoft Windows Installer program.

15. The data processing system of claim 14 wherein the analyzing module for analyzing the existing installation package of the first program includes examining the Feature, FeatureComponent and Component tables of the existing installation package for the first program.

16. The data processing system of claim 13 wherein each mergeable package created includes an identifier which is unique.

17. The data processing system of claim 13 further comprising a merging module for merging the mergeable packages into the installation package for the second program to create an installation package for a combination of the first and second programs.

18. The data processing system of claim 13 further comprising a repeating module for repeatedly creating mergeable packages from an existing installation package for a third program.

19. An article of manufacture for directing a data processing system operatively coupled to a data processing system usable memory tangibly embodying a software product installation package (SPIP) comprising software features (SFs) and software components (SCs) associated with the SFs, the data processing system implemented method of generating a set of installation merge packages (IMPs), the article of manufacture comprising:
a program usable medium embodying one or more instructions executable by the data processing system, the one or more instructions comprising:
data processing system executable instructions for associating a generated set of software feature merge packages (SFMPS) with a set of SFs selected from the SPIP;
data processing system executable instructions for identifying a shared SC, the identified shared SC being shared by the selected set of SFs;
data processing system executable instructions for inserting the identified shared SC into a generated common merge package (CMP);
data processing system executable instructions for associating the generated CMP with the generated set of SFMPs; and
data processing system executable instructions for inserting the generated CMP and the generated set of SFMPs into the IMPs.

20. The article of manufacture of claim 19 further comprising:
generating a SFMP, the generated SFMP having at least one SC associated with at least one SF of the SP.

21. An article of manufacture for directing a data processing system to construct, from an existing installation package used by an installation program to install a first computer program to be installed, at least one mergeable package to be merged with an installation package used by the installation program to install a second computer program, the first computer program having features implemented by components comprising portions of computer executable programs or data, the article of manufacture comprising:
a program usable medium embodying one or more instructions executable by the data processing system, the one or more instructions comprising:
data processing system executable instructions for analyzing the existing installation package for the first computer program to identify the features of the program and the components required to implement those features; and
data processing system executable instructions for defining, for each feature of the first program, at least one mergeable package containing components required to install a respective feature such that the mergeable packages for the installation of the respective feature do not contain any components not required by that respective feature and that components do not occur redundantly within the defined mergeable packages.

22. The article of manufacture of claim 21 further comprising:
data processing system executable instructions for identifying dependencies between the mergeable packages and recording identified dependencies in the respective mergeable package definitions; and
data processing system executable instructions for creating the mergeable packages from the mergeable package definitions and the existing installation package for the first program, the mergeable packages containing components and the information required by the installation program to install them.

23. The article of manufacture of claim 22 wherein the installation program is the Microsoft Windows Installer program.

24. The article of manufacture of claim 23 wherein the data processing system executable instructions for analyzing of the existing installation package of the first program comprises data processing system executable instructions for examining the Feature, FeatureComponent and Component tables of the existing installation package for the first program.

25. The article of manufacture of claim 22 wherein each mergeable package created includes an identifier which is unique.

26. The article of manufacture of claim 22 further comprising data processing system executable instructions for merging the mergeable packages into the installation package for the second program to create an installation package for a combination of the first and second programs.

27. The article of manufacture of claim 22 further comprising data processing system executable instructions for repeatedly creating mergeable packages from an existing installation package for a third program.
